(19) United States
(12) Patent Application Publication
(10) Pub. No.: US 2018/0239741 A1
(43) Pub. Date: Aug. 23, 2018

(54) METHODS AND SYSTEMS FOR AUTOMATICALLY IDENTIFYING KEYWORDS OF VERY LARGE TEXT DATASETS

(71) Applicant: General Electric Company, Schenectady, NY (US)

(72) Inventors: Rohit AGARWAL, Bangalore (IN); Praveen SINGH, Bangalore (IN); Rahul SRIVASTAVA, Bangalore (IN); Diwakar KASIBHOTLA, San Ramon, CA (US)

(21) Appl. No.: 15/435,933

(22) Filed: Feb. 17, 2017

(51) Int. Cl. G06F 17/21; G06F 17/30; G06F 17/24; G06F 17/27

(52) U.S. Cl. CPC G06F 17/211; G06F 17/30675; G06F 17/27; G06F 17/24; G06F 17/30719

(57) ABSTRACT

Methods and systems for automatically generating a list of keywords for an end user from very large amounts of text data. In an embodiment, a computer-implemented method includes a processor receiving a request from an end user device to generate a key word list, reading text data of a corpus of at least one domain, performing pre-processing of the text data of the corpus, and removing stop words. The process also includes generating, by the processor, a term document matrix, removing rare words, and identifying unigrams, bigrams and trigrams. The processor then performs a stemming process on the unigrams, bigrams and trigrams to form stem words, replaces each stem word with its highest frequency unigram to generate normalized unigrams, generates normalized bigrams and normalized trigrams based on the normalized unigrams, and generates a list of keywords comprising the normalized unigrams, the normalized bigrams, and the normalized trigrams.

### BACKGROUND

Machine and equipment assets, generally, are engineered to perform particular tasks as part of a business process. For example, assets can include, among other things and without limitation, industrial manufacturing equipment on a production line, drilling equipment for use in mining operations, wind turbines that generate electricity on a wind farm, transportation vehicles such as aircraft and/or locomotives, and the like. As another example, assets may include healthcare machines and equipment that aid in diagnosing patients such as imaging devices (e.g., X-ray or MM systems), monitoring devices, and the like. The design and implementation of these assets often takes into account both the physics of the task at hand, as well as the environment in which such assets are configured to operate.

Low-level software and hardware-based controllers have long been used to drive machine and equipment assets. However, the rise of inexpensive cloud computing systems and processes, the increase in sensor capabilities along with the decrease in sensor costs, as well as the proliferation of mobile technologies, have created opportunities for creating novel industrial and/or healthcare based assets with improved sensing technology which are also capable of transmitting data that can then be distributed throughout a network. As a consequence, new opportunities exist for enhancing the business value of some assets through the use of novel industrial-focused hardware and software.

One of the difficulties in designing a computing platform that supports machine focused software is the amount and the variety of applications and data that may be of interest to a user through the platform. For example, a power plant user or operator may be interested in viewing and interacting with numerous applications and systems related to the power plant in order to manage and/or view attributes or assets such as generators, cooling towers, a plant floor, materials, alerts, fuel usage, power protection, power distribution, control systems, and/or the like. During real world operation of such a power plant, a large amount of service data and/or maintenance data is typically generated by each of the assets, and the power plant operator may also wish utilize such data to model assets in the platform.

Recent research findings concerning the Internet of Things (“IoT”) predicts that upwards of fifty billion machines and/or sensors will be connected and/or interconnected via the Internet by the year 2020. Running and maintaining these interconnected machines produces (and will continue to produce) a huge volume of text data and/or text datasets. An example of text data includes, but is not limited to, the text generated to create a data record of conversations between maintenance engineers and/or analysts and/or manufacturers that take place whenever an issue occurs concerning equipment and/or a group of machines and/or hardware components. In another example, the text data may be in the form of maintenance logs which can include a list of issues and their resolutions, work orders and/or work order related information, and/or automatic alarms data and/or alerts data which can be generated by some machines and/or other types of equipment or components during normal operation.

Data visualizations, such as charts, graphs, infographics and the like, provide businesses and/or analysts with valuable ways to communicate important information at a glance. However, when raw data is text-based, it has been recognized that a WordCloud visualization presentation is a valuable format for highlighting important textual data points, such as keywords and/or impactful words, to convey crucial information. Such WordCloud visualizations, which are also known as “text clouds” and/or “tag clouds,” typically present specific words that appear most frequently in a source of textual data as larger and/or bolder than other words in the WordCloud. In this manner, the more frequently used words stand out from the rest so that a user can determine at a glance what words are important. A word cloud can therefore be equated to a weighted list in which a set of words, often words taken from a document or a plurality of associated documents, is displayed as on a page, and in which at least the font size of each depicted word varies depending on some attribute concerning the word. For example, the positions of the words in the word cloud could be determined by alphabetical order, and the size of a particular word in the word cloud could depend upon how frequently (how many times) that word appears in the document or documents of interest. The positioning of the words in the WordCloud visualization could also be determined by the size of the words, by some predetermined aesthetic consideration(s), and/or by using some additional information concerning the relationships between the words which the designer of the WordCloud wishes to convey. Some WordClouds also use colors and/or shading as well as frequency to depict something about the words; a bi-chromatic word cloud, for example, could include words that are highlighted in two colors that permits the viewer to see which person in a dialogue uttered a given word (for example, words uttered by speaker one are in red, while words uttered by speaker two are grey). A subtler use of coloring is exemplified by collocate clouds, which use shades of color to depict how frequently a given word appears only with another word the user has provided, while the size of a given word indicates how frequently that word appears in a document within a given distance of the word provided by the user.

A WordCloud that uses all of the attributes mentioned above to display some piece of information about a word can depict a surprising amount of data in an intuitively clear way, if properly designed. For example, word cloud visualizations can be a powerful tool for applications such as finding customer “pain points” by analyzing feedback textual data obtained from the customers and analyzing that data to determine what the customers like most about your business, and what they like least. The “pain points” or keywords could include such items as “price” and/or “convenience” and/or “wait time,” which are very easy to identify with WordCloud visualizations. However, WordCloud visualizations are generally avoided for situations in which the data is not optimized for context, because in such a case the WordCloud generator will produce a WordCloud visualization that will not provide any deep insights.

WordClouds necessarily involve a lot of searching, sorting, and computation involving large volumes of text data and thus are generally created by software. However, an analyst must guard against “analysis paralysis” (which is the state of over-analyzing data so no decision is reached) when reviewing a WordCloud visualization. For example, an analyst must take care when reviewing a WordCloud that has impactful words associated with certain issues that appear to be more dominant in a particular fleet of machines or other types of equipment than in others. Thus, a typical approach includes creating a list of pre-identified impactful words for every domain so that the user can extract desired information. However, a major draw-back with this approach is that the impactful word or keyword list is not scalable because such lists must be created manually for every industry or domain, and then must be updated every time a new word is introduced through any of the textual conversations concerning the machines and/or equipment for that industry.

Many software programs are available on the Internet (and/or on stand-alone computers) that generate various types of WordClouds, using the design parameters described above among others. Such WordCloud generation programs have a tendency to produce a single view of a given WordCloud, reflecting only one particularly interesting way of analyzing the textual or other data the program is designed to display. While the results can be fascinating, the programs currently in existence do not automatically highlight the key issues, key conversations, key alerts and the like that would or could be of most interest to a particular type of user. Thus, some irrelevant text data could be extracted (along with relevant text data) out of the huge volume of data and then presented to the user as a text cloud or WordCloud. Consequently, it would be desirable to provide a process that automatically highlights key issues, key conversations, key alerts and the like for a particular user.

### SUMMARY

Presented are methods and systems for automatically generating a list of keywords for an end user from very large amounts of text data. In an embodiment, a computer-implemented method includes a processor receiving a request from an end user device to generate a key word list, reading text data of a corpus of at least one domain, performing pre-processing of the text data of the corpus, and removing stop words. The process also includes generating, by the processor, a term document matrix, removing rare words, and identifying unigrams, bigrams and trigrams. The processor then performs a stemming process on the unigrams, bigrams and trigrams to form stem words, replaces each stem word with its highest frequency unigram to generate normalized unigrams, generates normalized bigrams and normalized trigrams based on the normalized unigrams, and generates a list of keywords comprising the normalized unigrams, the normalized bigrams, and the normalized trigrams.

In an aspect of an example embodiment, provided is a keyword list generating service system for automatically generating a keyword list. The keyword list generating system includes a cloud platform having a cloud computing system operably connected to a database, a user device operably connected to the cloud platform, and at least one domain including a plurality of assets operably connected to the cloud platform. In some embodiments, the database of the cloud platform stores instructions configured to cause the cloud computing system to receive a request from the end user device to generate a keyword list, read text data of a corpus of the at least one domain, perform pre-processing, remove stop words, generate a term document matrix, remove rare words, and identify unigrams, bigrams and trigrams. Also stored in the database of the cloud computing platform are instructions configured to cause the cloud computing system to form stem words by performing a stemming process on the unigrams, bigrams and trigrams, generate normalized unigrams by replacing each stem word with its highest frequency unigram, generate normalized bigrams and normalized trigrams, and generate a list of keywords comprising the normalized unigrams, the normalized bigrams, and the normalized trigrams.

Embodiments disclosed herein therefore provide a technical solution to the problem of how to automatically and efficiently generate a list of keywords for an end user from very large amounts of text data (or high volumes of text data), in particular for text data that is generated within an industrial environment (but in some implementations, the text data may be obtained from other types of environments or domains). In addition, some embodiments automatically provide keyword output data that can be utilized to generate and then to display an easily understandable visual presentation that can then be viewed by the user. Thus, the disclosed methods and/or systems satisfy the need for automatically providing a group of keywords in a manner that enables users to efficiently analyze a huge amount of text data, for example, to resolve current problems, and/or to predict future problems such that the user can act accordingly to prevent them. In some embodiments, the keywords associated with the very large amounts of text data pertaining to one or more machines are provided to the user in a cloud text visualization (WordCloud), which enables the user to find documents which contain information to help the user solve various types of machine-related problems and/or to take preventive measures regarding a plurality of machines and/or machine-related equipment so that, for example, the machines and/or equipment continue to run smoothly and/or efficiently.

Other features and aspects may be apparent from the following detailed description taken in conjunction with the drawings and the appended claims.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1 is a diagram illustrating a cloud computing environment associated with industrial systems in accordance with an example embodiment;

FIGS. 2A and 2B together form a flowchart illustrating a method for generating and providing a list of keywords to an end user according to some embodiments;

FIG. 3A is a WordCloud visualization of keywords generated by utilizing a conventional process on a corpus associated with an industrial domain;

FIG. 3B is a WordCloud visualization of keywords generated by utilizing the novel processes disclosed herein (on the same corpus utilized with regard to FIG. 3A) according to embodiments of the disclosure;

FIG. 4 is a block diagram illustrating an automatic keyword list generating service system according to an example embodiment; and

FIG. 5 is a diagram illustrating a computing device for automatically generating a keyword list in accordance with an example embodiment.

Throughout the drawings and the detailed description, unless otherwise described, the same drawing reference numerals will be understood to refer to the same elements, features, and structures. In addition, the relative size and depiction of some elements may be exaggerated and/or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown, but is to be accorded the widest scope consistent with the principles and features disclosed herein.

In general, and for the purpose of introducing concepts of novel embodiments described herein, provided are methods and systems for automatically generating a keyword list from a corpus, which information can then be presented to an end user in a manner which can be easily understood (for example, by providing a WordCloud visualization that includes highlighted impactful words or keywords, which may vary in font size and or ink color), and which thus can be utilized to gain insight concerning the text information. It should be noted that the term “impactful words” is used interchangeably herein with the word “keywords.” In some embodiments, the keywords are gleaned from very large amounts of text data, which may include thousands or even millions of records or documents (or more) containing text data. For example, high volumes of text data may be generated within an industrial environment, and it would be helpful for engineers and/or maintenance personnel to be able to quickly analyze such huge volumes of text data (which can originate from various sources) concerning one or more machines in the industrial environment. For example, a large amount of text data (i.e. several million records) may exist for a particular domain including, but not limited to, reports and/or documents that include conversations between maintenance engineers, analysts, and/or manufacturers related to issues that occurred regarding certain equipment, maintenance logs that include issues and resolution text data, work order-related text data, and/or alarms or alerts information generated by one or more sensors associated with one or more machines. The present methods and/or systems therefore satisfy the need for automatically generating keywords from a huge volume of text data (which may include millions of documents), and presenting the keywords in a manner that enables end users to easily and efficiently determine which keywords could be helpful to conduct a search for documents and/or reports that would aid in understanding and/or solving problems, and/or enable predictions and/or preventive measures to be taken before problems occur. For example, a WordCloud visualization may be created from a keywords list that was generated by utilizing the novel process(es) disclosed herein, which enables the user to quickly and easily determine which keyword(s) to use in a search to find documents that could aid in solving various types of machine-related problems, and/or to find documents describing problems which developed under similar conditions, so that the end user can find solutions and/or determine whether or not preventive measures should be taken, for example, to ensure that one or more of a plurality of machines and/or machine-related equipment continues to run smoothly and/or efficiently.

Although some examples of novel processes described herein relate to text data generated in association with machines and/or the industrial Internet of Things (IIoT), it should be understood that the novel processes described herein are domain agnostic (for example, the processes can be applied to large amounts of text data of various industries, such as aviation industry text data, hotel industry text data, entertainment industry text data, transportation industry text data, clean energy industry text data, healthcare industry text data, and the like), and are self-learning. In particular, the processes are self-learning because the generated list of impactful words or keywords may be re-created each time a new text data point and/or conversation is captured and/or stored. The impactful words and/or keywords can therefore be created dynamically, for example, as text data is generated during operation of an industrial machine and/or group or fleet of machines. In addition, the disclosed processes are self-tuning, and thus improved keyword accuracy can be achieved (as compared to manually creating a list of impactful words and/or keywords).

While progress with machine and equipment automation has been made over the last several decades, and assets (such as industrial machines) have become ‘smarter,’ the intelligence of any individual asset pales in comparison to intelligence that can be gained when multiple smart devices are connected together, for example, in the cloud. Assets, as described herein, may refer to equipment and machines used in fields such as energy, healthcare, transportation, heavy manufacturing, chemical production, printing and publishing, electronics, textiles, and the like. Aggregating data collected from or about multiple assets can enable users to improve business processes, for example by improving effectiveness of asset maintenance or improving operational performance if appropriate industrial-specific data collection and modeling technology is developed and applied.

For example, an asset can be outfitted with one or more sensors configured to monitor respective operations or conditions. Data from the sensors can be recorded or transmitted to a cloud-based or other remote computing environment. By bringing such data into a cloud-based computing environment, new software applications informed by industrial process, tools and know-how can be constructed, and new physics-based analytics specific to an industrial environment can be created. Insights gained through analysis of such data can lead to enhanced asset designs, enhanced software algorithms for operating the same or similar assets, better operating efficiency, and the like. In addition, large amounts of text data may be generated and stored, such as the text data associated with conversations between maintenance engineers, analysts, and/or manufacturers whenever issues occur concerning one or more assets. Such text data may also include, but is not limited to, maintenance logs that include issues which occurred and their resolutions, work order related information, and alarms and/or alerts information or data associated with one or more assets.

Assets can include or can be a portion of an Industrial Internet of Things (IIoT). In an example, an IIoT connects assets including machines and equipment, such as turbines, jet engines, healthcare machines, locomotives, and the like, to the Internet or cloud, or to each other in some meaningful way, for example, through one or more networks. The systems and methods described herein can include using a “cloud” or remote or distributed computing resource or service. The cloud can be used to receive, relay, transmit, store, analyze, and/or otherwise process information for or about one or more assets. In an example, a cloud computing system includes at least one processor circuit, at least one database, and a plurality of users and/or assets that are in data communication with the cloud computing system. The cloud computing system can further include, or can be coupled with, one or more other processor circuits or modules configured to perform a specific task, such as to perform tasks related to asset maintenance, asset analytics, asset data storage, security, and/or some other function(s).

However, the integration of assets with the remote computing resources to enable the IIoT often presents technical challenges separate and distinct from the specific industry and from computer networks, generally. A given machine or equipment based asset may need to be configured with novel interfaces and/or communication protocols to send and receive data to and from distributed computing resources. Certain assets may have strict requirements for cost, weight, security, performance, signal interference, and the like such that enabling such an interface is rarely as simple as combining the asset with a general purpose computing device. In addition, assets are in real-world operation and thus may generate huge amounts of servicing data and/or operational data and/or related textual data over time, which data is stored and is retrievable and needs to be presented in a manner that enables an end user, for example, to obtain and view the data in order to maintain assets, solve problems as they arise, and/or prevent issues from occurring.

The Predix™ platform available from the General Electric Company (GE) is a novel embodiment of an Asset Management Platform (AMP) technology enabled by state of the art cutting edge tools and cloud computing techniques that enable incorporation of a manufacturer's asset knowledge with a set of development tools and best practices that enables asset users to bridge gaps between software and operations to enhance capabilities, foster innovation, and ultimately provide economic value. Through the use of such a system, a manufacturer of assets can be uniquely situated to leverage its understanding of assets themselves, models of such assets, and industrial operations or applications of such assets, to create new value for industrial customers through asset insights.

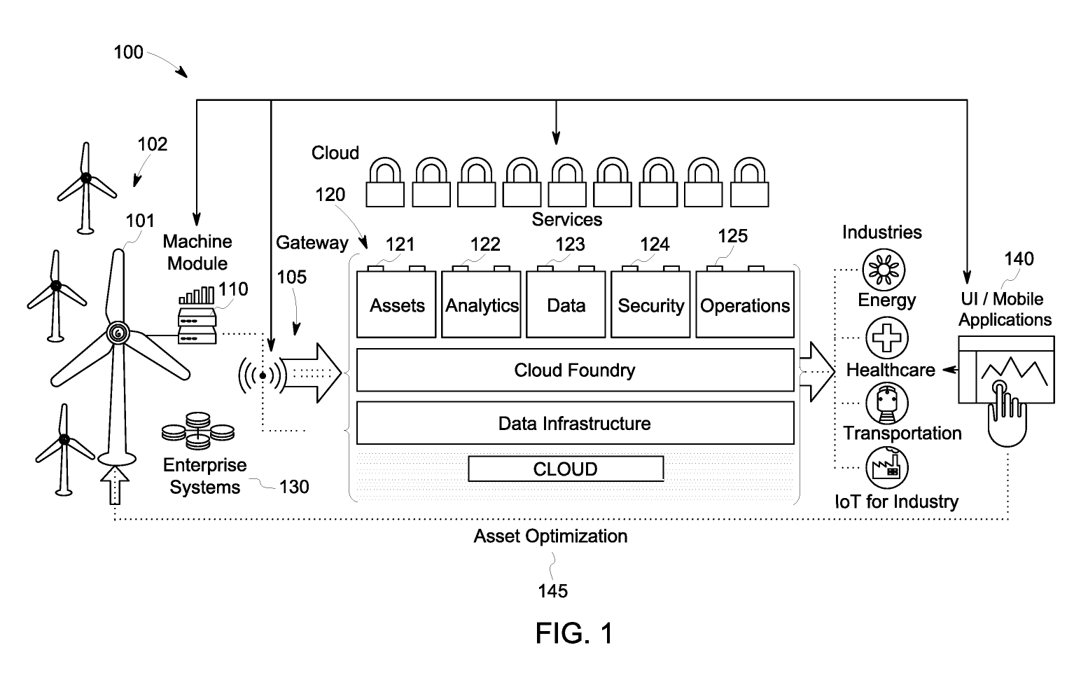

FIG. 1 illustrates a cloud computing environment associated with industrial systems in accordance with an example embodiment. FIG. 1 generally illustrates an example of portions of an asset management platform (AMP) 100. As further described herein, one or more portions of an AMP can reside in a cloud computing system 120, in a local or sandboxed environment, or can be distributed across multiple locations or devices. The AMP 100 can be configured to perform any one or more of data acquisition, data storage, data analysis, and/or data exchange with local or remote assets, or with other task-specific processing devices. The AMP 100 includes an asset community (e.g., turbines, healthcare machines, industrial, manufacturing systems, etc.) that is communicatively coupled with the cloud computing system 120. In an example, a machine module 110 receives information from, or senses information about, at least one asset member of the asset community, and configures the received information for exchange with the cloud computing system 120. In an example, the machine module 110 is coupled to the cloud computing system 120 or to an enterprise computing system 130 via a communication gateway 105.

In some embodiments, the communication gateway 105 includes or uses a wired or wireless communication channel that extends at least from the machine module 110 to the cloud computing system 120. The cloud computing system 120 may include several layers, for example, a data infrastructure layer, a cloud foundry layer, and modules for providing various functions. In the example shown in FIG. 1, the cloud computing system 120 includes an asset module 121, an analytics module 122, a data acquisition module 123, a data security module 124, and an operations module 125. Each of these modules includes or uses a dedicated circuit, or instructions for operating a general purpose processor circuit, to perform the respective functions. In an example, the modules 121-125 are communicatively coupled in the cloud computing system 120 such that information from one module can be shared with another. In an example, the modules 121-125 are co-located at a designated datacenter or other facility, or the modules 121-125 can be distributed across multiple different locations.

An interface device 140 (e.g., user device, workstation, tablet, laptop, appliance, kiosk, and the like) can be configured for data communication with one or more of the machine module 110, the gateway 105, and the cloud computing system 120. The interface device 140 can be used to monitor and/or control one or more assets. As another example, the interface device 140 may be used to develop and upload applications to the cloud computing system 120. As yet another example, the interface device 140 may be used to access analytical applications hosted by the cloud computing system 120. In some embodiments, information about the asset community may be presented to an operator at the interface device 140. The information about the asset community may include information from the machine module 110, and/or the information can include information from the cloud computing system 120. The interface device 140 can include options for optimizing one or more members of the asset community based on analytics performed at the cloud computing system 120. In addition, the interface device 140 may include an option for obtaining text data from one or more members of the asset community and then perform a process to provide a keyword list of normalized keywords in accordance with methods described herein, which normalized keyword list can then be utilized by an end user to determine search words and/or parameters to find documents that may aid in solving problems and/or preventing a problem from occurring.

As a non-limiting example, an end user of the interface device 140 may control an asset through the cloud computing system 120, for example, by selecting a parameter update for a first wind turbine 101. In this example, the parameter update may be pushed to the first wind turbine 101 via one or more of the cloud computing system 120, the gateway 105, and the machine module 110. In some examples, the interface device 140 is in data communication with the enterprise computing system 130 and the interface device 140 provides an operation with enterprise-wide data about the asset community in the context of other business or process data. For example, choices with respect to asset optimization can be presented to an operator in the context of available or forecasted raw material supplies or fuel costs. As another example, choices with respect to asset optimization can be presented to an operator in the context of a process flow to identify how efficiency gains or losses at one asset can impact other assets.

In another non-limiting example, an end user of the interface device 140 may obtain text data of the industrial assets through the cloud computing system 120 by using a keyword list generating process service as disclosed herein. For example, the end user can select a corpus associated with the asset community including multiple wind turbine assets, including the first wind turbine 101. However, it should be understood that wind turbines are merely used in this example as a non-limiting example of a type of asset that can be a part of, or in data communication with, the asset management platform (AMP) 100. Thus, other types of industrial assets may also be associated with the AMP 100. The end user can then initiate the keyword list process as disclosed herein to automatically obtain a keyword list that can be used to conduct further analysis of documents stored by the cloud computing system 120 that are associated with the asset community of wind turbines.

Referring again to FIG. 1, a device gateway 105 is configured to couple the asset community to the cloud computing system 120. In some implementations, the device gateway 105 can also couple the cloud computing system 120 to one or more other assets or asset communities, to the enterprise computing system 130, or to one or more other devices. The AMP 100 thus represents a scalable industrial solution that extends from a physical or virtual asset (e.g., the first wind turbine 101) to a remote cloud computing system 120. The cloud computing system 120 optionally includes a local, system, enterprise, or global computing infrastructure that can be optimized for industrial data workloads, secure data communication, and compliance with regulatory requirements.

The cloud computing system 120 can include the operations module 125. The operations module 125 can include services that developers can use to build or test Industrial Internet applications, and the operations module 125 can include services to implement Industrial Internet applications, such as in coordination with one or more other AMP modules. In an example, the operations module 125 includes a microservices marketplace where developers can publish their services and/or retrieve services from third parties. In addition, the operations module 125 can include a development framework for communicating with various available services or modules. The development framework can offer developers a consistent look and feel and a contextual user experience in web or mobile applications. Developers can add and make accessible their applications (services, data, analytics, etc.) via the cloud computing system 120.

Information from an asset, about the asset, or sensed by an asset itself may be communicated from the asset to the data acquisition module 123 in the cloud computing system 120. For example, one or more external sensors can be used to sense information about a function of an asset, or to sense information about environmental conditions at or near an asset. Such external sensors can be configured for data communication with the device gateway 105 and with the data acquisition module 123. The cloud computing system 120 can also be configured to use sensor information in its analysis of one or more assets, for example, by using the analytics module 122. Using a result from the analytics module 122, an operational model can optionally be updated, such as for subsequent use in optimizing the first wind turbine 101 or one or more other assets, such as one or more assets in the same or different asset community. For example, information about the first wind turbine 101 can be analyzed at the cloud computing system 120 to inform selection of an operating parameter for a remotely located second wind turbine that belongs to a different asset community.

The cloud computing system 120 may include a Software-Defined Infrastructure (SDI) that serves as an abstraction layer above any specified hardware, which can enable a data center to evolve over time with minimal disruption to overlying applications. The SDI enables a shared infrastructure with policy-based provisioning to facilitate dynamic automation, and enables service level agreement (SLA) mappings to underlying infrastructure. This configuration can be useful when an application requires an underlying hardware configuration. The provisioning management and pooling of resources can be done at a granular level, thus allowing optimal resource allocation. In addition, the asset cloud computing system 120 may be based on Cloud Foundry (CF), an open source platform-as-a-service (PaaS) that supports multiple developer frameworks and an ecosystem of application services. Cloud Foundry can make it faster and easier for application developers to build, test, deploy, and scale applications. In such embodiments, developers gain access to the vibrant CF ecosystem and an ever-growing library of CF services. Additionally, because it is open source, CF can be customized for IIoT workloads.

In addition, the cloud computing system 120 can include a data services module that can facilitate application development. For example, the data services module can enable developers to bring data into the cloud computing system 120 and to make such data available for various applications, such as applications that execute at the cloud, at a machine module, or at an asset or other location. In an example, the data services module can be configured to cleanse, merge, or map data before ultimately storing it in an appropriate data store, for example, at the cloud computing system 120. In some embodiments, special emphasis is placed on time series data, as it is the data format that most sensors use. In addition, in some embodiments text data may be obtained and stored by the data services module for use by end users to research problems and/or issues that may occur with regard to one or more assets.

Security can be a concern for data services that exchange data between the cloud computing system 120 and one or more assets or other components. Some options for securing data transmissions include using Virtual Private Networks (VPN) or a secure socket layer (SSL)/transport layer security (TLS) model. In an example, the AMP 100 can support two-way TLS, such as between a machine module and the security module 124. In another example, two-way TLS may not be supported, and the security module 124 can treat client devices as Open Authorization (OAuth) users. For example, the security module 124 can allow enrollment of an asset (or other device) as an OAuth client and transparently use OAuth access tokens to send data to protected endpoints.

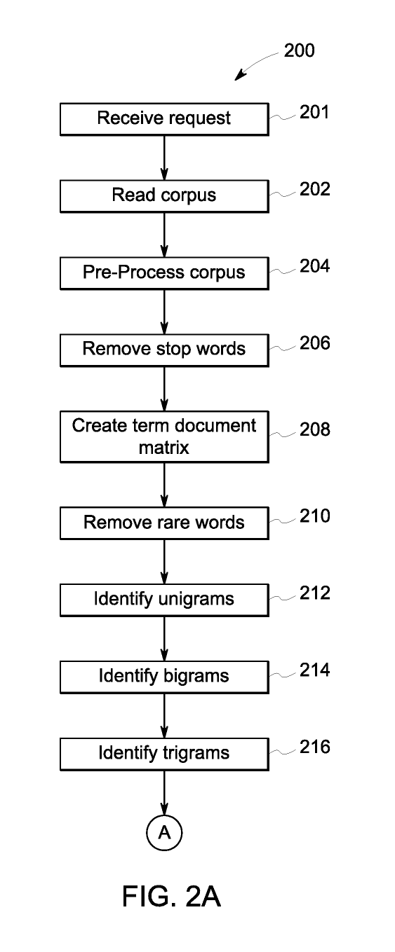

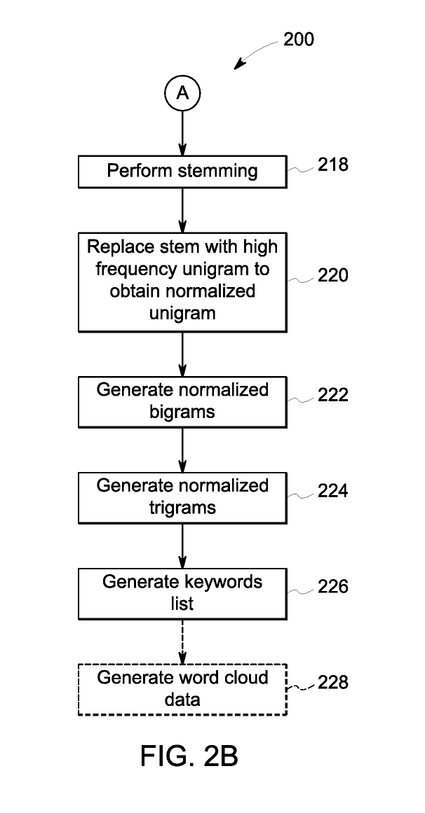

FIGS. 2A and 2B together form a flowchart 200 depicting a method for automatically providing a list of keywords (or impactful words) in accordance with some embodiments of this disclosure. Before describing FIGS. 2A and 2B in detail, at this point terminology used in association with the novel processes described herein will be explained. In particular, the word “document” as used herein means any textual unit or text data unit upon which analytics are to be applied, for example, to diagnose a case and/or to diagnose symptoms of a case. The word “term” as used herein means a word within a document. The word “corpus” means a collection of documents upon which analysis are to be performed. Examples of corpus include, but are not limited to case data documents, alert data documents, maintenance logs in maintenance and diagnostics (M&D) systems, and/or work orders in Systems, Applications and Products (SAP) systems.

An “N-gram” is a contiguous sequence of N items or N words from a given sequence of text, and such items can represent phonemes, syllables, letters, words or base pairs according to the application, which are collected from a text corpus. For example, an N-gram of one (1) could be the word “Rotor” (which is a unigram), while an N-gram of two (2) could be “Rotor Fan” (which is called a bigram), and an N-gram of three may be “Rotor Fan Vibration” (which is called a trigram). In the examples of the process described herein the N-grams are restricted to trigrams, but it should be understood that the process supports N-Gram implementation of four or more.

“Stop words” are terms within a document that add little value to any text analysis and thus are considered to be noise. For example, commonly occurring words in the text such as the word “the” and/or “a” and/or “of” are stop words, and therefore such stop words are generally removed before any text analysis is performed. Stop words are known, and thus stop word lists are commonly available and may be utilized as part of the novel processes described herein.

“Stemming” is the process of reducing inflected (or sometimes derived) words to their word stem or root. For example, the words “closely,” “close,” “closed,” and “closure” have as their root the word “close.” Consequently, after stemming, each of these words would be represented by the word “close.” Standard “stemmer” algorithms and/or processes and/or subroutines are known, and may be utilized as an element in one or more of the novel processes described herein.

“Term Frequency” means the number of times a term appears in a document, and a “Term Document Matrix” (TDM) is a matrix that describes the frequency of terms occurring in a collection of documents. In some TDMs, the rows correspond to terms, the columns correspond to the documents in the collection, and the value in each cell is the term frequency. An example of a Term Document Matrix is shown below in Table 1:

TABLE 1

| | D₁ | D₂ | D₃ | . . . | Dₙ |
|---|---|---|---|---|---|
| T₁ | 1 | 0 | 1 | . . . | 0 |
| T₂ | 1 | 1 | 0 | . . . | 1 |
| T₃ | 7 | 8 | 3 | . . . | 4 |
| Tₙ | 2 | 1 | 1 | . . . | 3 |

With reference to Table 1, for example, the term “T₁” occurs in document one (D₁) once, does not occur in document two (D₂) or document N (D₀), and only once in document three (D₃). An example of a probable keyword (which generally is a term that appears frequently within the TDM) here is T₃, which appears seven times in document one (D₁), eight times in document two (D₂), three times in document three (D₃) and four times in document N (D₀). However, further processing may be needed to confirm that T₃ is indeed a keyword. In contrast, the terms T₁ and T₂ may not be considered keywords, for example, if the number of occurrences of those terms falls below a predetermined threshold value. Thus, in some embodiments, rare terms are defined as all words which occur in less than one percent (1%) of the total documents (corpus), and thus these rare words are removed from the term document matrix because such rare words do not have much analytical value because they occur only a minimal amount of times in the documents.

As mentioned above, FIGS. 2A and 2B illustrate a process 200 for automatically generating a list of impactful words (keywords) and then presenting them to a user in accordance with some embodiments. In some implementations, due to the vast amount of text data to process, the method 200 is performed by a cloud computing system or other type of computer network (not shown). However, in some cases wherein the corpus includes text data records that number a few thousand or less, a user may be able to utilize a laptop computer and/or personal computer for generating the list of keywords and viewing the keyword list output.

Referring to FIG. 2A, in an implementation a processor of a cloud computing system receives 201 a request from a user to generate a keyword list, and then reads 202 a corpus (which is a collection of documents, for example, obtained from a Manufacturing and Distribution (M&D) system, or from a Customer Relationship Management (CRM) system). The corpus is typically specified by the user, and/or may be defined by the type of problem the user is attempting to solve and/or the domain in which the issue resides. For example, a user may identify an issue with a power generating turbine wherein over the past month one or more sensors have detected a lube oil filter alert including pressure differences, and indicating that feathering has also occurred. Consequently, a corpus that includes documents associated with such an industrial environment (and that includes wind turbine operation text data) is designated or specified by the user for searching, so that the user can analyze the keyword list output for keywords that could help the user find documents which may include one or more solutions to the problem(s). For example, if the process identifies keywords and presents them to the user which include the words “lube oil filter,” and/or “feathering”, and/or “diff pressure” then these keywords can be utilized by the user to find documents which may give the user an insight about the particular problem(s) concerning the lube oil filter and why it may have something to do with feathering and/or differential pressure readings. One can easily appreciate the value of having a list of keywords while searching for similar cases from a set of thousands or perhaps millions of documents associated with old cases, as such keywords help to narrow down and/or quickly sift through the tremendous amount of old cases. A particular advantage of the methods disclosed herein is that keywords can be generated without the user having any prior knowledge or predefined list of such keywords or impactful words. Such a process therefore removes the need to create or pre-identify impactful words or keywords for each and every domain that could be searched, which would be very time consuming as well as impractical because there can be large number of domains and because text data is constantly being generated by engineers, technicians, vendors and the like, as machines and/or systems continue to operate.

Referring again to FIG. 2A, the processor next performs pre-processing 204 of the corpus. Pre-processing can include performing one or more basic cleanup procedures, such as removing punctuation, digits, trailing whitespaces, and/or control characters from the text data of the corpus. Pre-processing may also include putting the textual data into lower case. Next, the processor performs 206 removals (or filtering out) of stop words from the corpus to ensure that only potential keywords are left. Examples of stop words can include, but are not limited to common words such as: “the”, “a”, “of”, “an”, “and”, “at”, “be”, “been”, “can”, “good”, “got”, “has”, “in”, “it”, and many others (it should be understood that pre-defined lists of stop words exist and are freely available for use). The processor next creates 208 a term document matrix based on the cleaned-up corpus. This resulting term document matrix contains all the remaining terms in the corpus (after the pre-processing) and the frequency with which they appear in different documents. For example, a term document matrix such as that shown above in Table 1 can be generated, and will contain many terms (T₁ to Tₙ) and a plurality of documents (D₁ to Dₙ). However, not all of these terms can be classified as keywords (or impactful words), and thus the processor next removes 210 the “rare” terms from the term document matrix. In some embodiments, the rare terms may be identified by using predetermined criteria, for example, all terms that occur less than a predetermined amount of times (a threshold value) are rare terms. Thus, in some implementations, the rare terms may be defined as all words which occur in less than one percent (1%) of the total number of documents (corpus), or may be defined as all terms that occur less than “X” amount of times (for example, all terms that occur less than twenty-five (25) times in the documents of the corpus are rare words). Such rare words are then removed from the term document matrix because these rare words do not have much analytical value. Consequently, the result is a term document matrix that can be analyzed to find the keywords for the end user.

In some implementations, keywords are defined as frequently occurring unigrams, bigrams and trigrams. At this point in the process 200 of FIGS. 2A and 2B, the terms in the term document matrix are the candidates to be considered as unigrams (individual words), as they all occur a significant amount of times in the corpus (i.e., it has already been established that the terms occur in more than 1% of the documents in the corpus and these terms are not stop words). Thus, referring again to FIG. 2A, the processer identifies unigrams 212, then the processor combines the unigrams to form and identify bigrams 214. Bigrams are checked by the processor against the corpus for validity and frequency purposes, and in some implementations all the bigrams that occur at least a threshold amount of times (for example, bigrams that occur at least ten (10) times) in the entire corpus are identified as bigrams. An examples of a bigram in an industrial environment is “bearing metal.” Similarly, the processor identifies trigrams 216 by combining three (3) unigrams, and in some implementations all the trigrams that occur at least a threshold amount of times (for example, eight (8) times) in the entire corpus are identified as trigrams. An example of a trigram is “bearing metal vibration.”

At this point in the process, a first cut of the keywords has been generated. However, situations may occur wherein the unigrams are different only in terms of cardinality, like “temperature” and “temperatures,” or only differ by tense, like “close” and “closed.” Thus, in some implementations, a normalization process is performed to remove these minor differences, and thus unigrams are translated to their stems in an operation known as “stemming.” Stemming is the process of reducing inflected words to their word stem, base or root form. For example, Table 2 below shows unigrams reduced to their stem in the order of their corpus frequency:

TABLE 2

| Unigram | Stem | Corpus Frequency |
|---|---|---|
| changed | chang | 17 |
| changes | chang | 38 |
| changing | chang | 79 |
| change | chang | 104 |

Referring to FIG. 2B, the processor therefore next performs stemming 218 on each unigram, and then later replaces 220 the stem word with the highest frequency unigram (for each individual unigram) to obtain normalized unigrams. As an example, with regard to Table 2 above, the unigram “change” has the highest frequency (104) and thus would replace the stem “chang” in the resulting keyword list. This is done because the end user is expecting the keywords in the output keywords list to resemble actual words that occur in the text and not some translated form, such as a stem.

Next, the processor generates 222 normalized bigrams by utilizing the normalized unigrams (i.e., since each bigram consists of two unigrams, the two unigrams of a bigram are replaced with their normalized versions). For example, the bigrams “vibration increased” and “vibrations increase” are both changed to “vibration increase.” The processor also generates 224 normalized trigrams by similarly utilizing the normalized unigrams (i.e., since a trigram consists of three unigrams, the three unigrams of a trigram are replaced with their normalized versions). Next, in some embodiments, the processor may add 226 domain knowledge and/or domain information to obtain keywords. For example, a unigram such as “vlv” and/or “brg” may exist in many documents, which are known abbreviations in an industrial environment for the words “valve” and “bearing,” respectively. Domain knowledge would then be used to expand those abbreviations, without which such unigrams cannot be expanded because the stemming process will not be able to handle such abbreviations. Accordingly, in some implementations a list of commonly occurring abbreviations and their expanded form may be made available so that the processor can expand the abbreviations and apply them to the normalized keywords. For example, when such an abbreviation list is utilized by the processor, the bigram “brg vibr” is changed to “bearing vibration” for further processing.

Referring again to FIG. 2B, the processor then generates 226 a keyword list that can be used for analysis purposes. For example, the keyword list data may be input to a processor to product an output in the form of a text data visualization, such as a chart, a graph, or some other type of infographic that a user can review and analyze in order to determine which keywords should be used to conduct a search for a documents to review that would be applicable to figuring out a solution to a particular problem. Thus, in some embodiments, the processor optionally generates 228 WordCloud data which can be utilized by the end user to produce and view a WordCloud visualization of the keyword.

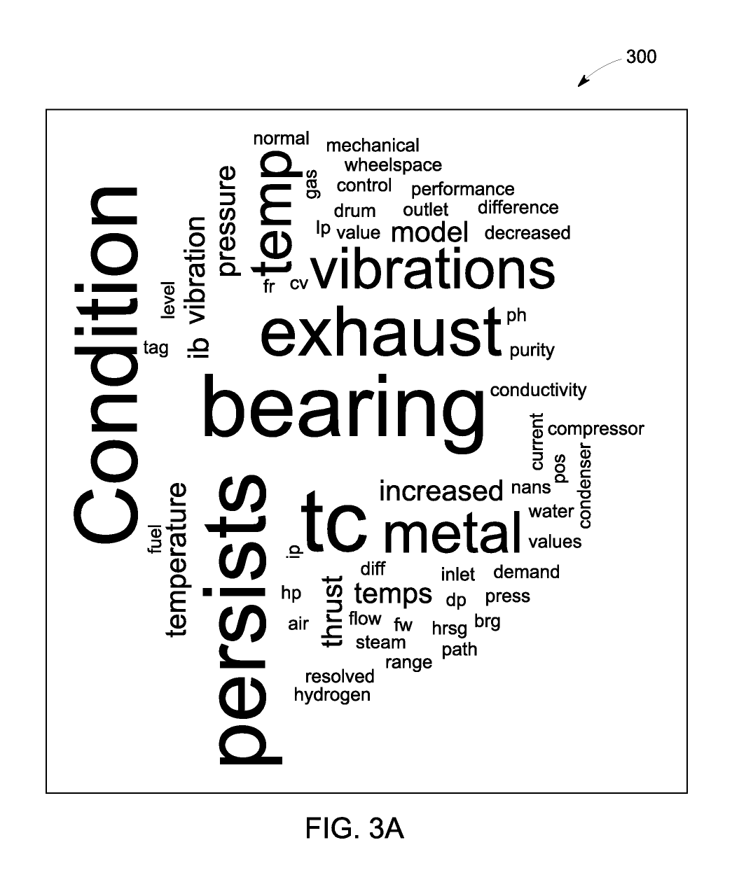

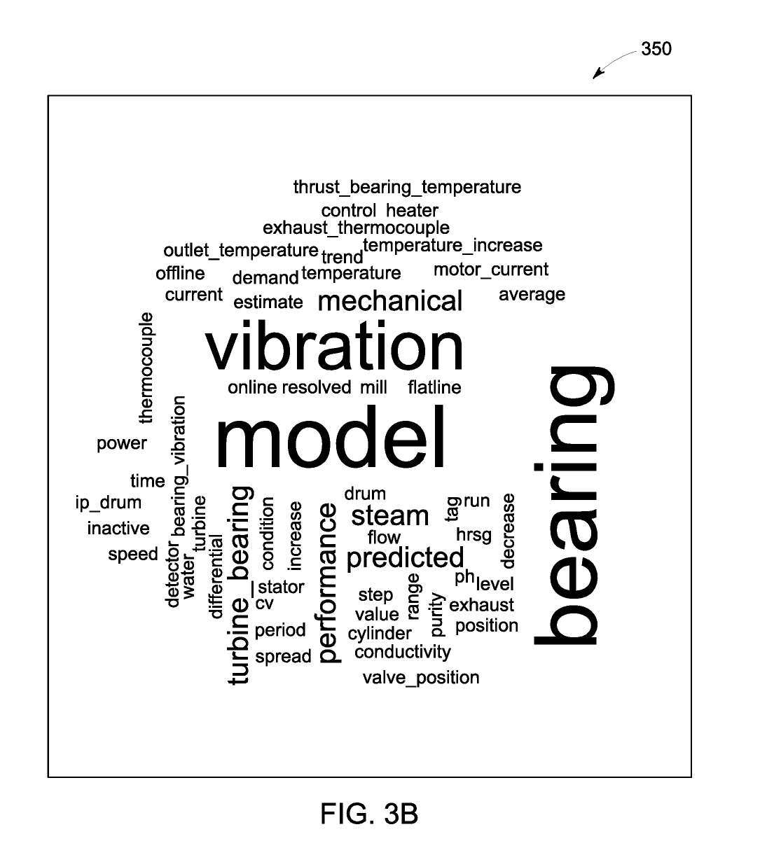

FIG. 3A illustrates an example of a WordCloud visualization 300 of keywords generated by utilizing a conventional WordCloud generation process on a corpus associated with an industrial domain, whereas FIG. 3B illustrates a WordCloud visualization 350 of keywords generated for the same corpus by utilizing the processes disclosed herein within the same industrial domain. In this example, four thousand (4000) smart signal cases (the corpus) included text data associated with an industrial machines domain. Accordingly, keywords such as “turbines,” “bearings,” “rotors” and other machine parts and conditions were included therein, and about 800 keywords were generated. A frequency distribution of these keywords was then plotted by using about two thousand (2000) of the cases, and then the distribution depicted in the form of the WordClouds as shown in FIGS. 3A and 3B.

Referring to FIG. 3A, the WordCloud visualization 300 (or term frequency map) was created by a conventional WordCloud process on a corpus that included text data of cases from an Application Performance Management (APM) system. The conventional process did not normalize the keywords (as disclosed with regard to the novel processes described herein). Thus, the conventional process read the text data of a corpus, pre-processed the text data to remove one or more of punctuation, digits, trailing whitespaces, and control characters, removed stop words, created a term document matrix, and then removed rare words. However, as shown, the resulting WordCloud visualization 300 has various issues that are detrimental to performing any analysis, which include the abbreviation “temp” and the word “temperature” appearing separately (but are the same), the words “press” and “pressure” appearing separately (but are the same), the words “vibration” and “vibrations” appearing separately (but they only differ in cardinality, and thus should have been combined), and the abbreviation “tc” and the word “thermocouple” appearing separately (despite being the same). In addition, some words in this corpus should have been found to frequently occur together, such as “bearing vibration,” which are not shown in the WordCloud visualization 300, and thus there is a loss of information that would have been helpful to the end user.

In contrast, the WordCloud 350 shown in FIG. 3B, which was generated from keyword data generated by using the novel processes disclosed herein, contains useful information for the end user. In particular, in addition to reading the text data of a corpus, pre-processing the text data to remove at least one of punctuation, digits, trailing whitespaces, and control characters, removing stop words, creating a term document matrix, and removing rare words (based on the term document matrix), the processor also identified unigrams, combined the unigrams to generate bigrams, and combined the unigrams to generate trigrams. (Thus, unigrams, bigrams and trigrams are all present in the WordCloud visualization 350, whereas bigrams and trigrams are absent from the WordCloud 300.) In addition, the processor performed a stemming process on the unigrams, bigrams and trigrams to form stem words, and then replaced each stem word with its highest frequency unigram to generate normalized unigrams. The processor also generated normalized bigrams based on the normalized unigrams, and generated normalized trigrams based on the normalized unigrams. The processor then generated a list of keywords including the normalized unigrams, the normalized bigrams, and the normalized trigrams, which are presented in the WordCloud 350 that includes the impactful words or keywords depicted in a large font, such as “model,” “bearing” and “vibration.” It should be noted that the novel process disclosed herein took about one minute (sixty seconds) to generate keywords which resulted in the WordCloud visualization 350, which would have taken much longer if done manually, and would have been less accurate.

It should be noted that the impactful words “vibration,” “model,” and “bearing” are shown in large font in the WordCloud 350 of FIG. 3B, but do not present in that manner in the WordCloud 300 of FIG. 3A. In addition, the words “temp” and “vibrations,” which appear in the WordCloud of FIG. 3A are not included in FIG. 3B (because they have been combined with the words “temperature” and “vibration,” respectively) and that bigrams such as “exhaust thermocouple” and “outlet temperature” and “bearing temperature” appear in FIG. 3B, but such information is missing from FIG. 3A. In addition, the trigram “thrust bearing temperature” appears in FIG. 3B because it is of some interest, but this trigram is missing from FIG. 3A. Accordingly, the WordCloud visualization 350 provides more accurate and additional information to the end user for use in analyzing the keywords. Thus, the end user can better determine what keyword searches could (and should) be used to find documents that may contain text information that is highly applicable to one or more problems that the end user is trying to solve, or which may contain relevant information that can be used by the user to prevent a problem from occurring.

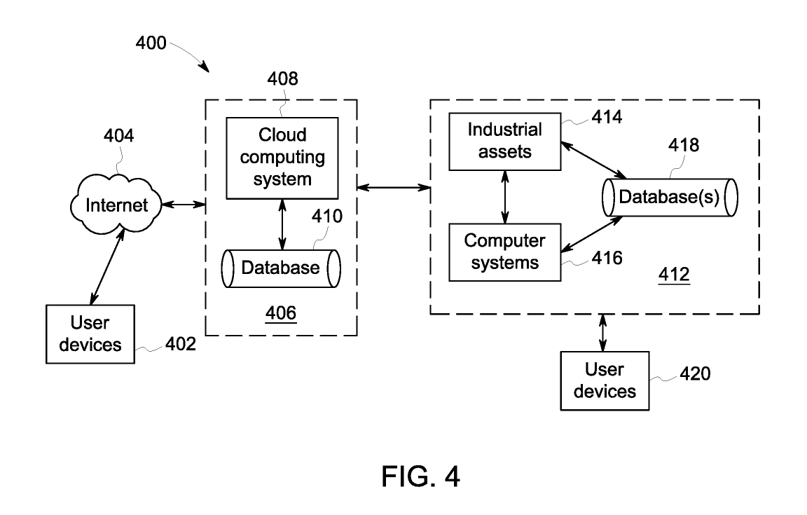

FIG. 4 is a block diagram illustrating an automatic keyword list generating service system 400 for generating a keyword list for an end user in a cloud computing environment according to some embodiments. The system 400 includes an end user device 402 in communication with a cloud platform 406 via the Internet 404, but another type of network such a private network could be utilized to operably connect an end user device 402 to the cloud platform instead of, or in combination with, the Internet 404. The end user device 402 can be any type of communication device, such as a smart phone, tablet computer, laptop computer, a workstation, an appliance and the like. In this example, the cloud platform 404 includes a cloud computer system 408 (which may include one or more computer servers) and at least one database 410 which stores instructions and/or data. The cloud platform 404 is shown in communication with an industrial domain 412 that includes a plurality of Industrial Assets 414 (such as a number of wind turbines) operably connected to a computer system 416, which is operably connected to a database 418. The computer system 416 may include one or more server computers, and may operate to obtain and store various types of data associated with the industrial assets 414, including text data, in the database 418. Also shown is a plurality of user devices 420, which may be in communication with the industrial domain 412 via a network (not shown), and which may accommodate users who are tasked with monitoring and/or maintaining the industrial assets. For the sake of simplicity, only one domain (the industrial domain 412) is shown in FIG. 4, but in reality a plurality of such domains may be included, wherein each of the domains is in communication with the cloud platform 406 and operable to provide data, including text data, associated with their domain. Accordingly, end users utilizing user devices 402 can transmit a request to the cloud platform 406 to provide a keyword list associated with a particular domain (or with a plurality of selected domains), which keyword list is then created automatically in accordance with the processes described herein.

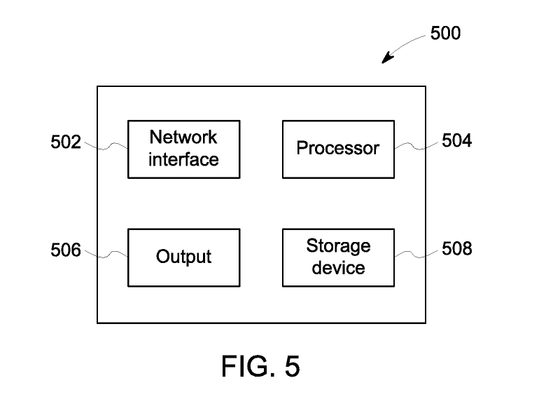

FIG. 5 illustrates a computing device 500 for automatically generating a keyword list in accordance with an example embodiment. The device 500 may be a cloud computing device in a cloud platform, or another device. Also, the device 500 may perform the method 200 of FIGS. 2A and 2B. Referring to FIG. 5, the device 500 includes a network interface 502, a processor 504, an output 506, and a storage device 508. Although not shown in FIG. 5, the device 500 may include other components such as a touch screen display, an input unit, a receiver/transmitter component, and the like. The network interface 502 may transmit and receive data over a network such as the Internet, a private network, a public network, and the like. The network interface 502 may be a wireless interface, a wired interface, or a combination thereof. The processor 504 may include one or more processing devices each including one or more processing cores, and may include non-conventional processing devices specifically designed to optimize the processing of text data to generate a keyword list. In some examples, the processor 504 is a multicore processor or a plurality of multicore processors. Also, the processor 504 may be fixed or it may be reconfigurable. The output 506 may be configured to output data to an embedded display of the device 500, an externally connected display, a cloud, another device, and the like. The storage device 508 is not limited to any particular storage device and may include any known memory device such as RAM, ROM, hard disk, and the like.

According to various embodiments, the network interface 502 may receive a request for generating a keyword list, for example, from a user device. The request may include an indication of a particular domain and/or domains and/or other data. The processor 502 may then execute the steps required to provide normalized unigrams, bigrams and trigrams as disclosed herein, and then may utilized the list to create a WordCloud visualization for display to the user. The user may then determine which of the keywords of the WordCloud visualization could be helpful, and then transmit a request to the computing device 500 to run a search for documents containing certain selected keywords. In some embodiments, a list of documents satisfying the user's search request is generated by the computing device 500 and transmitted to the user for further consideration.

Thus, according to various embodiments, provided herein is an automated keyword generation process which may be executed by a cloud platform and/or computing device. In particular, a computer-implemented embodiment generates keywords for an end user, and includes at least one processor that reads text data of a corpus, pre-processes the corpus to remove at least one of punctuation, digits, trailing whitespaces, and control characters from the text data of the corpus, removes stop words, and creates a term document matrix. The processor then removes rare words (based on the term document matrix), identifies unigrams, combines the unigrams to generate bigrams, and combines the unigrams to generate trigrams. The processor then performs a stemming process on the unigrams, bigrams and trigrams to form stem words, and replaces each stem word with its highest frequency unigram to generate normalized unigrams. The processor also generates normalized bigrams based on the normalized unigrams, and generates normalized trigrams based on the normalized unigrams. Lastly, the processor generates a list of keywords including the normalized unigrams, the normalized bigrams, and the normalized trigrams. In some implementations, the normalized unigrams, the normalized bigrams, and the normalized trigrams are utilized to create a WordCloud visualization with is presented to the end user. The end user can then easily determine which keywords occur most often, and decide which keyword(s) to use which may be applicable to a particular problem or issue that the end user is trying to solve, or is trying to prevent. A search request can then be generated to conduct a search for documents that may be helpful for the end user to review with regard to that particular problem, in an effort to solve the problem and/or to prevent the problem from occurring in the future.

Thus, by using the processes disclosed herein, an end user can obtain a list of keywords which can be used to obtain insights about the text data and/or documents of a corpus. The keyword list can also be utilized for text analytics purposes. For example, text analysis of the keywords may be used to help remove redundant words, synonyms, and low frequency words from the corpus to thus improve the quality of the results. The resultant keyword list can be used for performing further analysis like clustering, topic modelling, and frequency graphs (such as generating a WordCloud).

A particular advantage of the methods disclosed herein is that keywords can be generated for an end user without the end user having any prior knowledge or predefined list of such keywords or impactful words. Thus, the disclosed processes remove the need to create or pre-identify impactful words or keywords for each and every domain, which would be very time consuming as well as impractical because there can be large number of domains and because text data is constantly being generated as machines and/or systems operate. Accordingly, the disclosed processes help to create the list of keywords much faster as compared to a manually curated list. In addition, the novel processes described for generating a list of keywords (for example in a WordCloud visualization) are generic and thus can be applied to the corpus of multiple domains. Moreover, the processes are self-learning because the list of keywords is automatically updated if and/or when the corpus is updated.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non-transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, semiconductor memory such as read-only memory (ROM), and/or any transmitting/receiving medium such as the Internet, cloud storage, the internet of things (IoT), or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

What is claimed is:

1. A computer-implemented method for automatically generating a list of keywords from text data, comprising:
receiving, by a processor, a request from an end user device to generate a keyword list;
reading, by the processor, text data of a corpus of at least one domain;
performing, by the processor, pre-processing of the text data of the corpus;
removing, by the processor, stop words from the pre-processed text data;
generating, by the processor, a term document matrix comprising the pre-processed text data without stop words in comparison to a plurality of documents of the corpus;
removing, by the processor based on predetermined criteria and information provided by the term document matrix, rare words;
identifying, by the processor, unigrams, bigrams and trigrams;
performing, by the processor, a stemming process on the unigrams, bigrams and trigrams to form stem words;
replacing, by the processor, each stem word with its highest frequency unigram to generate normalized unigrams;
generating, by the processor, normalized bigrams and normalized trigrams based on the normalized unigrams; and
generating, by the processor, a list of keywords comprising the normalized unigrams, the normalized bigrams, and the normalized trigrams.

2. The method of claim 1, wherein pre-processing comprises removing, by the processor, at least one of punctuation, digits, trailing whitespaces, and control characters from the text data of the corpus.

3. The method of claim 1, wherein pre-processing comprises replacing, by the processor, capital letters in the text data of the corpus with lower case letters.

4. The method of claim 1, wherein the predetermined criteria for removing rare terms comprises a requirement to remove all terms that occur in less than one percent (1%) of the documents of the corpus.

5. The method of claim 1, wherein the predetermined criteria for removing rare terms comprises a requirement to remove all terms that occur less than a predetermined number of times in the documents of the corpus.

6. The computer-implemented method of claim 1, further comprising creating, by the processor, a WordCloud of the keywords for display to the end user.

7. A non-transitory computer readable medium storing instructions configured to cause a computer to:
receive a request to generate a keyword list;
read text data of a corpus of at least one domain;
perform pre-processing of the text data of the corpus;
remove stop words from the pre-processed text data;
generate a term document matrix comprising the pre-processed text data without stop words in comparison to a plurality of documents of the corpus;
remove, based on predetermined criteria and information provided by the term document matrix, rare words;
identify unigrams, bigrams and trigrams;
form stem words by performing a stemming process on the unigrams, bigrams and trigrams;
generate normalized unigrams by replacing each stem word with its highest frequency unigram;
generate normalized bigrams and normalized trigrams based on the normalized unigrams; and
generate a list of keywords comprising the normalized unigrams, the normalized bigrams, and the normalized trigrams.

8. The non-transitory computer readable medium of claim 7, wherein the instructions for pre-processing comprise instructions configured to cause the computer to remove at least one of punctuation, digits, trailing whitespaces, and control characters from the text data of the corpus.

9. The non-transitory computer readable medium of claim 7, wherein the instructions for pre-processing comprise instructions configured to cause the computer to replace capital letters in the text data of the corpus with lower case letters.

10. The non-transitory computer readable medium of claim 7, wherein the predetermined criteria contained in the instructions for removing rare terms comprises a requirement to remove all terms that occur in less than one percent (1%) of the documents of the corpus.

11. The non-transitory computer readable medium of claim 7, wherein the predetermined criteria contained in the instructions for removing rare terms comprises a requirement to remove all terms that occur less than a predetermined number of times in the documents of the corpus.

12. The non-transitory computer readable medium of claim 7, further comprising instructions configured to cause the computer to create a WordCloud of the keywords for display to the end user.

13. A keyword list generating service system for automatically generating a keyword list, comprising:
a cloud platform comprising a cloud computing system operably connected to a database;
a user device operably connected to the cloud platform; and
at least one domain comprising a plurality of assets operably connected to the cloud platform;
wherein the database of the cloud platform stores instructions configured to cause the cloud computing system to:
receive a request from the end user device to generate a keyword list;
read text data of a corpus of the at least one domain;
perform pre-processing of the text data of the corpus;
remove stop words from the pre-processed text data;
generate a term document matrix comprising the pre-processed text data without stop words in comparison to a plurality of documents of the corpus;
remove, based on predetermined criteria and information provided by the term document matrix, rare words;
identify unigrams, bigrams and trigrams;
form stem words by performing a stemming process on the unigrams, bigrams and trigrams;
generate normalized unigrams by replacing each stem word with its highest frequency unigram;
generate normalized bigrams and normalized trigrams based on the normalized unigrams; and
generate a list of keywords comprising the normalized unigrams, the normalized bigrams, and the normalized trigrams.

14. The system of claim 13, further comprising a communication network operably connecting the cloud computing system to the user device.

15. The system of claim 13, wherein the plurality of assets of the at least on domain comprises a plurality of industrial assets operably connected to a computer system and at least one database.

16. The system of claim 13, wherein the instructions for pre-processing are configured to cause the cloud computing system to remove at least one of punctuation, digits, trailing whitespaces, and control characters from the text data of the corpus.

17. The system of claim 13, wherein the instructions for pre-processing are configured to cause the cloud computing system to replace capital letters in the text data of the corpus with lower case letters.

18. The system of claim 13, wherein the predetermined criteria contained in the instructions for removing rare terms comprises a requirement for the cloud computing system to remove all terms that occur in less than one percent (1%) of the documents of the corpus.

19. The system of claim 13, wherein the predetermined criteria contained in the instructions for removing rare terms comprises a requirement for the cloud computing system to remove all terms that occur less than a predetermined number of times in the documents of the corpus.

20. The system of claim 13, wherein the database stores further instructions configured to cause the cloud computing system to create a WordCloud of the keywords for display on a display component of the user device.
